(19) United States
(12) Patent Application Publication
(10) Pub. No.: US 2011/0151211 A1
(43) Pub. Date: Jun. 23, 2011

(54) METHOD FOR MAKING A DESIRED PATTERN OF A METALLIC NANOSTRUCTURE OF A METAL

(76) Inventors: Yu-Hsu Chang, Taoyuan County (TW); Jia-Sin Wang, Keelung City (TW)

(21) Appl. No.: 12/794,855

(22) Filed: Jun. 7, 2010

(30) Foreign Application Priority Data
Dec. 23, 2009 (TW) 098144459

(51) Int. Cl. B32B 3/10; B05D 1/36; B32B 15/00

(52) U.S. Cl. 428/209; 427/265; 977/700; 977/890

(57) ABSTRACT

A method for making a desired pattern of a metallic nanostructure of a metal includes: (a) forming the desired pattern of a self-assembled monolayer matrix of a first organic compound on a substrate, the first organic compound having a tail group selected to be active toward deposition of the metal on the self-assembled monolayer matrix; (b) forming an inert layer of a second organic compound on the substrate by contacting an assembly of the substrate and the self-assembled monolayer matrix with a solution containing the second organic compound, the second organic compound having a tail group selected to be inactive toward the deposition of the metal on the inert layer; and (c) depositing the metal on the self-assembled monolayer matrix by contacting an assembly of the substrate, the self-assembled monolayer matrix and the inert layer with a solution containing metal ions, followed by reducing the metal ions.

### CROSS-REFERENCE TO RELATED APPLICATION

This application claims priority of Taiwanese Application No. 098144459, filed on Dec. 23, 2009.

### BACKGROUND OF THE INVENTION

1. Field of the Invention

This invention relates to a method for making a desired pattern of a metallic nanostructure of a metal, more particularly to a method for making a desired pattern of a metallic nanostructure of a metal using nanolithography.

2. Description of the Related Art

Lithography is an important technique in microfabrication, nanofabrication, and preparation of molecular electronics. Dip pen nanolithography (DPN) is widely used for making molecular electronics.

Referring to FIGS. 1A and 1B, a first conventional method involving the use of the DPN technique for making a desired pattern of a metallic nanostructure is shown to include forming a patterned layer 20 of an organic compound 201 on a metal layer 101 of a substrate 10 through the use of a nanoscopic tip coated with the organic compound 201, as best shown in FIG. 1A, and etching the metal layer 101 that is not covered by the patterned layer 20, as best shown in FIG. 1B, so as to obtain the desired pattern of the metallic nanostructure.

Referring to FIGS. 2A and 2B, a second conventional method involving the use of the DPN technique for making a desired pattern of a metallic nanostructure is shown to include forming a self-assembled monolayer (SAM) 20 of an organic compound 201 through immersing the substrate 10 containing a metal layer 101 into a solution that contains the organic compound 201 (such as thiols), as best shown in FIG. 2A, and removing a portion of the self-assembled monolayer 20 through the use of a nanoscopic tip to expose a portion of the metal layer 101 that forms the desired pattern of the metallic nanostructure, as best shown in FIG. 2B.

Referring to FIGS. 3A, 3B, and 3C, a third conventional method involving the use of the DPN technique for making a desired pattern of a metallic nanostructure, which is disclosed in Jayne C. Garno, Christopher D. Zangmeister, and James D. Batteas, “Directed Electroless Growth of Metal Nanostructures on Patterned Self-Assembled Monolayers,” Langmuir, 2007, 23, pp. 7874-7879, is shown to include forming a resist layer of a first organic compound 201 on a substrate 10, as best shown in FIG. 3A, replacing a portion of the first organic compound 201 of the resist layer through the use of a nanoscopic tip so as to form a patterned matrix layer of a second organic compound 202, as best shown in FIG. 3B, and forming a metal layer 30 on the matrix layer of the second organic compound 202, as best shown in FIG. 3C, so as to form the desired pattern of the metallic nanostructure.

In the second and third conventional methods, since the nanoscopic tip is used to remove a portion of the self-assembled monolayer or the resist layer on the substrate, there is a tendency to damage the substrate during the removal operation.

### SUMMARY OF THE INVENTION

Therefore, an object of the present invention is to provide a simple and convenient method for making a desired pattern of a metallic nanostructure of a metal that can overcome the aforesaid drawback associated with the prior art.

According to this invention, there is provided a method for making a desired pattern of a metallic nanostructure of a metal, which comprises: (a) forming the desired pattern of a self-assembled monolayer matrix of a first organic compound on a pattern-forming surface of a substrate through nanolithography, the first organic compound having a head group bonded to the substrate and a tail group distal from the substrate and selected to be active toward deposition of the metal on the self-assembled monolayer matrix; (b) forming an inert layer of a second organic compound on a portion of the pattern-forming surface of the substrate that is exposed from the self-assembled monolayer matrix by contacting an assembly of the substrate and the self-assembled monolayer matrix with a solution containing the second organic compound, the second organic compound having a head group bonded to the substrate and a tail group distal from the substrate and selected to be inactive toward the deposition of the metal on the inert layer; and (c) depositing the metal on the self-assembled monolayer matrix by contacting an assembly of the substrate, the self-assembled monolayer matrix and the inert layer with a solution containing ions of the metal, followed by reducing the ions of the metal in the solution to allow the deposition of the metal on the self-assembled monolayer matrix to take place.

### BRIEF DESCRIPTION OF THE DRAWINGS

Other features and advantages of the present invention will become apparent in the following detailed description of the preferred embodiment of this invention, with reference to the accompanying drawings, in which:

FIGS. 1A and 1B are schematic diagrams illustrating consecutive steps of the first conventional method for making a desired pattern of a metallic nanostructure;

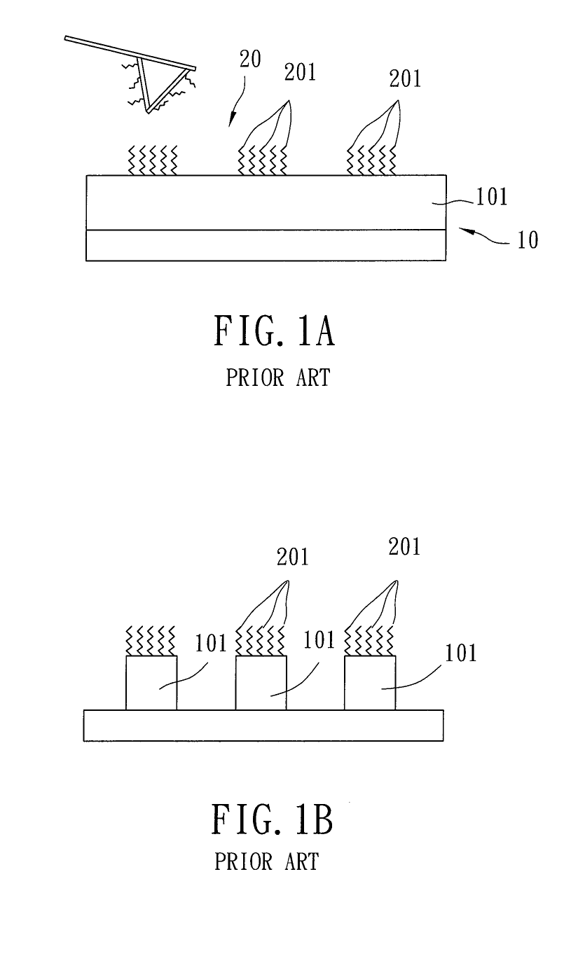

FIGS. 2A and 2B are schematic diagrams illustrating consecutive steps of the second conventional method for making a desired pattern of a metallic nanostructure;

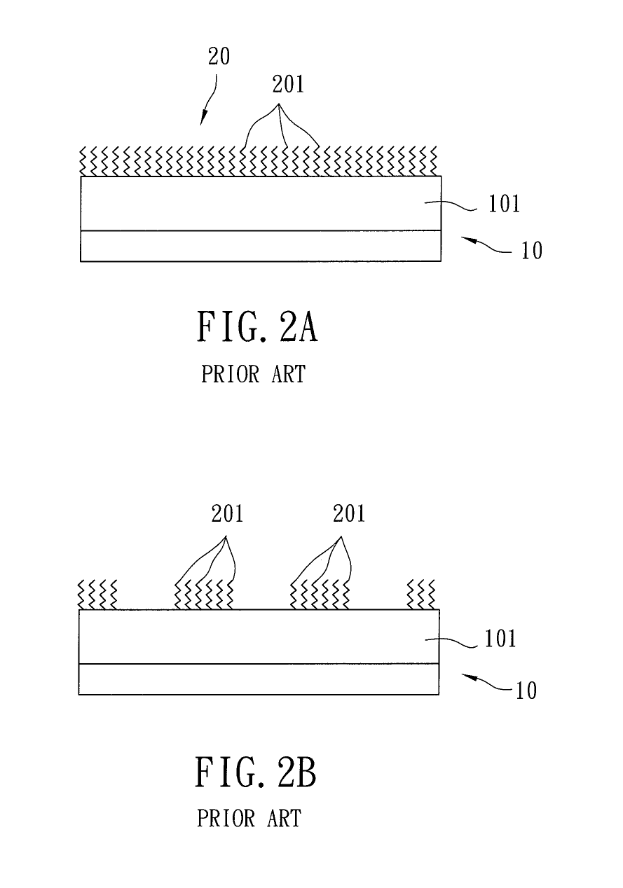

FIGS. 3A, 3B, and 3C are schematic diagrams illustrating consecutive steps of the third conventional method for making a desired pattern of a metallic nanostructure; and

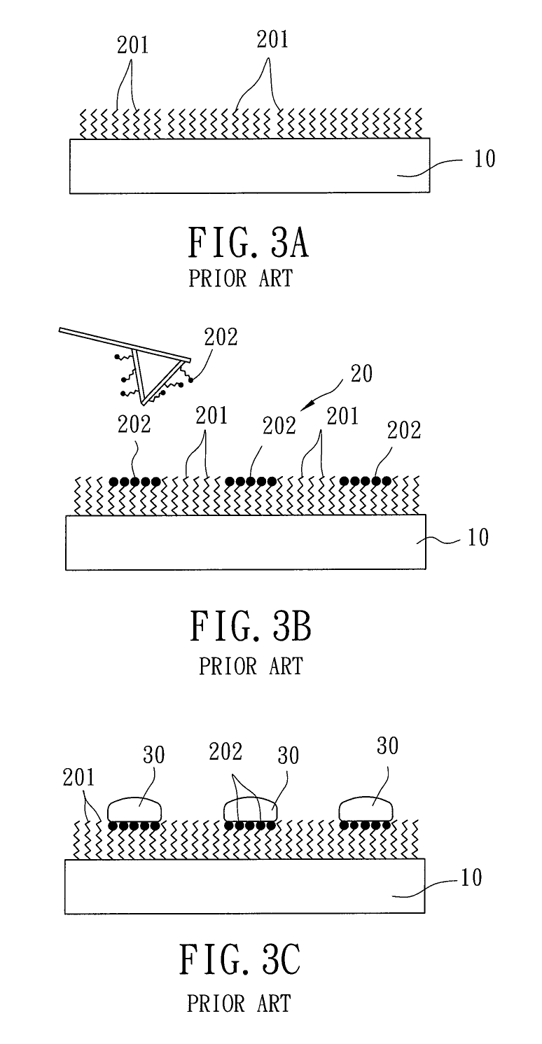

FIGS. 4A, 4B and 4C are schematic diagrams illustrating consecutive steps of a preferred embodiment of a method for making a desired pattern of a metallic nanostructure according to this invention.

### DETAILED DESCRIPTION OF THE PREFERRED EMBODIMENT

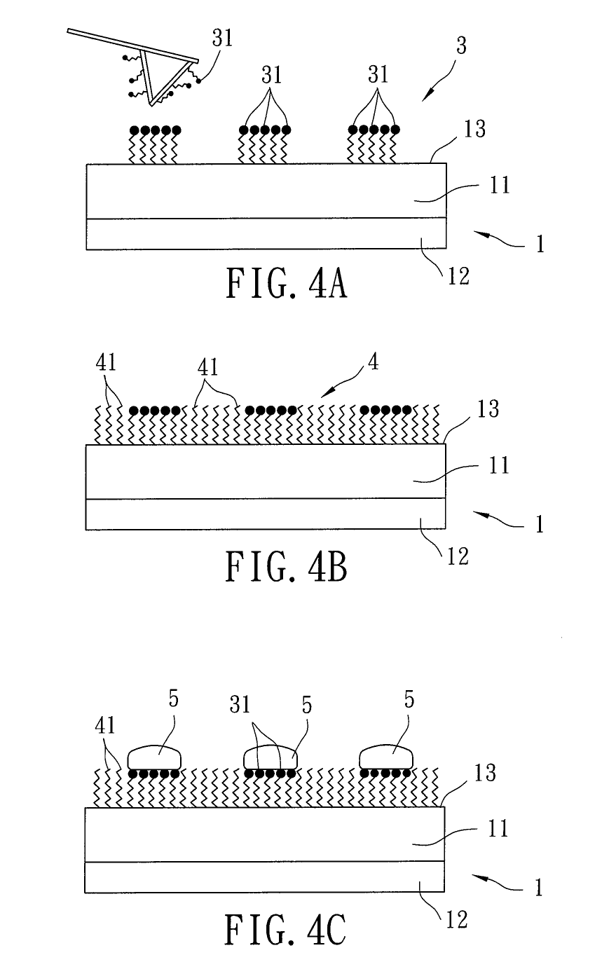

Referring to FIGS. 4A, 4B, and 4C, a preferred embodiment of a method for making a desired pattern of a metallic nanostructure of a metal according to this invention includes: (a) forming the desired pattern of a self-assembled monolayer matrix 3 of a first organic compound 31 on a pattern-forming surface 13 of a substrate 1 through nanolithography, the first organic compound 31 having a head group bonded to the substrate 1 and a tail group distal from the substrate 1 and selected to be active toward deposition of the metal on the self-assembled monolayer matrix 3, as best shown in FIG. 4A; (b) forming an inert layer 4 of a second organic compound 41 on a portion of the pattern-forming surface 13 of the substrate 1 that is exposed from the self-assembled monolayer matrix 3 by contacting an assembly of the substrate 1 and the self-assembled monolayer matrix 3 with a solution containing the second organic compound 41, the second organic compound 41 having a head group bonded to the substrate 1 and a tail group distal from the substrate 1 and selected to be inactive toward the deposition of the metal on the inert layer 4, as best shown in FIG. 4B; and (c) depositing the metal on the self-assembled monolayer matrix 3 by contacting an assembly of the substrate 1, the self-assembled monolayer matrix 3, and the inert layer 4 with a solution containing ions of the metal, followed by reducing the ions of the metal in the solution to allow the deposition of the metal on the self-assembled monolayer matrix 3 to take place, so as to form a patterned metal layer 5, as best shown in FIG. 4C.

Preferably, the substrate 1 includes a base layer 12, and a metal layer 11 that defines the pattern-forming surface 13.

Examples of the material of the base layer 12 include, but are not limited to, silica wafer, mica, metal and metal oxide.

The metal layer 11 of the substrate 1 may be formed through sputtering or evaporation techniques. Preferably, the metal layer 11 is made from a metal, such as gold, silver, copper, or palladium, or alloys thereof.

Preferably, the tail group of the first organic compound 31 has an affinity for the metal. More preferably, the first organic compound 31 is represented by a formula of HS—R¹—X¹, in which R¹ is a C₁˜C₃₀ alkylene group, and X¹ is SH, OH, COOH, NH₂ or CONH₂. Examples of the first organic compound 31 include, but are not limited to, 11-mercaptoundecanol, 6-mercaptohexanol, and 16-mercaptohexadecanoic acid.

The nanolithography may be micro-contact printing, dip pen nanolithography, photolithography, or e-beam lithography. Preferably, the nanolithography in step (a) is a dip-pen nanolithography with the use of a nanoscopic tip coated with the first organic compound 31.

Preferably, the solution in step (b) contains the second organic compound 41 and a solvent. A non-limiting example of the solvent is ethanol.

Preferably, the second organic compound 41 is represented by a formula of HS—R²—X², in which R² is a C₁˜C₃₀ alkylene group, and X² is a methyl group or a halogenated methyl group, such as CF₃, CCl₃, or CBr₃. Examples of the second organic compound 41 include, but are not limited to, 1-propanethiol, 1-dodecanethiol, and 1-octadecanethiol.

The contacting time in step (b) is preferably from 12 hours to 16 hours. The assembly of the substrate 1, the self-assembled monolayer matrix 3 and the inert layer 4 obtained in step (b) may be cleaned by ethanol and distilled water.

Preferably, the method further includes a step of contacting the assembly of the substrate 1, the self-assembled monolayer matrix 3 and the inert layer 4 with a solution containing an activating agent after step (b) and prior to step (c) so as to form nucleating centers of the activating agent on the self-assembled monolayer matrix 3.

Preferably, the activating agent contains at least a metal ion, such as copper ion, gold ion, silver ion, palladium ion, nickel ion, iron ion, aluminum ion, and tin ion. More preferably, the activating agent contains a solvent and a metallic compound. An example of the metallic compound is copper perchlorate.

A non-limiting example of the solution in step (c) is a stock solution for the electroless plating of copper, which is prepared by dissolving copper sulfate (CuSO₄.5H₂O) and sodium hydrogen tartrate in distilled water to form a mixture, followed by subjecting the mixture to ultrasonic vibration for 20 minutes, adjusting pH of the mixture to 12˜13 through addition of NaOH (aq), and adding 2 v/v % of formaldehyde into the mixture.

In conclusion, by forming the inert layer 4 on the substrate 1 after formation of the desired pattern of the self-assembled monolayer matrix 3 on the substrate 1 in the method of this invention, the aforesaid drawback associated with the prior art can be eliminated.

While this invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A method for making a desired pattern of a metallic nanostructure of a metal, comprising:
(a) forming the desired pattern of a self-assembled monolayer matrix of a first organic compound on a pattern-forming surface of a substrate through nanolithography, the first organic compound having a head group bonded to the substrate and a tail group distal from the substrate and selected to be active toward deposition of the metal on the self-assembled monolayer matrix;
(b) forming an inert layer of a second organic compound on a portion of the pattern-forming surface of the substrate that is exposed from the self-assembled monolayer matrix by contacting an assembly of the substrate and the self-assembled monolayer matrix with a solution containing the second organic compound, the second organic compound having a head group bonded to the substrate and a tail group distal from the substrate and selected to be inactive toward the deposition of the metal on the inert layer; and
(c) depositing the metal on the self-assembled monolayer matrix by contacting an assembly of the substrate, the self-assembled monolayer matrix and the inert layer with a solution containing ions of the metal, followed by reducing the ions of the metal in the solution to allow the deposition of the metal on the self-assembled monolayer matrix to take place.

2. The method of claim 1, wherein the tail group of the first organic compound has an affinity for the metal.

3. The method of claim 1, wherein the nanolithography in the step (a) is dip-pen nanolithography with the use of a nanoscopic tip coated with the first organic compound.

4. The method of claim 1, wherein the first organic compound is represented by a formula of HS—R¹—X¹, in which R¹ is a C₁˜C₃₀ alkylene group, and X¹ is selected from the group consisting of SH, OH, COOH, NH₂, and CONH₂.

5. The method of claim 1, wherein the second organic compound is represented by a formula of HS—R²—X², in which R² is a C₁˜C₃₀ alkylene group, and X² is selected from the group consisting a methyl group and a halogenated methyl group.

6. The method of claim 1, wherein the substrate includes a base layer and a metal layer that defines the pattern-forming surface of the substrate, the metal layer being made from a metal or an alloy thereof, said metal being selected from the group consisting of gold, silver, copper, and palladium.

7. The method of claim 1, further comprising contacting the assembly of the substrate, the self-assembled monolayer matrix and the inert layer with a solution containing an activating reagent after step (b) and prior to step (c) so as to form nucleating centers of the activating reagent on the self-assembled monolayer matrix.

8. The method of claim 7, wherein the activating reagent contains at least one metal ion selected from the group consisting of copper ion, gold ion, silver ion, palladium ion, nickel ion, iron ion, aluminum ion, and tin ion.

9. An article comprising a pattern of a metallic nanostructure of a metal made according to the method of claim 1.
